(19) United States
(12) Patent Application Publication
(10) Pub. No.: US 2024/0020721 A1
(43) Pub. Date: Jan. 18, 2024

(54) INFORMATION PROCESSING DEVICE

(71) Applicant: SUBARU CORPORATION, Tokyo (JP)

(72) Inventor: Yuji TANAKA, Tokyo (JP)

(21) Appl. No.: 18/476,875

(22) Filed: Sep. 28, 2023

Related U.S. Application Data
(63) Continuation of application No. PCT/JP2022/015955, filed on Mar. 30, 2022.

(51) Int. Cl. G06Q 30/0235; G06Q 30/0251; G01C 21/34

(52) U.S. Cl. CPC G06Q 30/0235; G06Q 30/0259; G06Q 30/0266; G01C 21/3476; G01C 21/3682

(57) ABSTRACT

An information processing device includes a presentation controller. The presentation controller is configured to present, to a user, a store that is extracted based on route information relating to a route on which a vehicle travels and store information including a period in which a bonus is provided. The store is where the vehicle can arrive in the period in which the bonus is provided. The store information includes at least a start time of the bonus. The presentation controller is configured to present, to the user, the store where the vehicle can arrive within a predetermined time range before the start time.

### CROSS REFERENCE TO RELATED APPLICATIONS

This application is continuation of International Application No. PCT/JP2022/015955, filed on Mar. 30, 2022, the entire contents of which are hereby incorporated by reference.

### BACKGROUND

The present disclosure relates to an information processing device.

There has been proposed an information processing device of related art that presents a product or a service that can be provided after an elapse of a predetermined period in accordance with an expected position after the elapse of the predetermined period (for example, refer to Japanese Unexamined Patent Application Publication No. 2017-174453).

### SUMMARY

An aspect of the disclosure provides an information processing device including a presentation controller. The presentation controller is configured to present, to a user, a store that is extracted based on route information relating to a route on which a vehicle travels and store information including a period in which a bonus is provided. The store is where the vehicle can arrive in the period in which the bonus is provided. The store information includes at least a start time of the bonus. The presentation controller is configured to present, to the user, the store where the vehicle can arrive within a predetermined time range before the start time.

An aspect of the disclosure provides an information processing device including circuitry. The circuitry is configured to present, to a user, a store that is extracted based on route information relating to a route on which a vehicle travels and store information including a period in which a bonus is provided. The store is where the vehicle can arrive in the period in which the bonus is provided. The store information includes at least a start time of the bonus. The circuitry is configured to present, to the user, the store where the vehicle can arrive within a predetermined time range before the start time.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a diagram illustrating a configuration of a bonus store presentation system for presenting a store in which a user can receive a bonus according to an embodiment;

FIG. 2 is a diagram illustrating a list of store information;

FIG. 3 is a diagram illustrating a list of store information;

FIG. 4 is a diagram illustrating a configuration of an information processing device;

FIG. 5 is a diagram illustrating a navigation screen;

FIG. 6 is a diagram illustrating a presentable period set with reference to a start time;

FIG. 7 is a diagram illustrating a presentable period based on a start time and an end time;

FIG. 8 is a diagram illustrating an example of presenting a store in which the user can receive a bonus;

FIG. 9 is a diagram illustrating an example of presenting a store in which the user can receive a bonus; and

FIG. 10 is a flowchart illustrating a flow of bonus store presentation processing.

### DETAILED DESCRIPTION

Stores may provide various bonuses such as a limited-time sale to a user in a certain period. However, the information processing device of the related art did not present a bonus provided in a store to the user.

It is desirable to give a sense of satisfaction to a user by presenting a store in which the user can receive a bonus.

### 1. Outline of Configuration of Bonus Store Presentation System

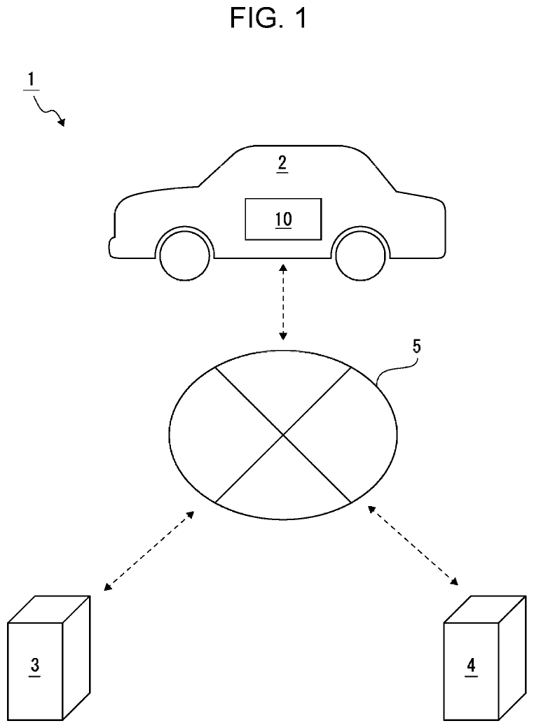

FIG. 1 is a diagram illustrating a configuration of a bonus store presentation system 1 for presenting a store in which a user can receive a bonus according to an embodiment. As illustrated in FIG. 1, the bonus store presentation system 1 includes a vehicle 2, a server device 3, and a store terminal device 4. The vehicle 2, the server device 3, and the store terminal device 4 can be connected to one another via a network 5. As the network 5, any of various networks such as a cellular phone network, a mobile communication network, a satellite communication network, the Internet, an intranet, and an extranet is assumed.

In the bonus store presentation system 1, as long as the vehicle 2 and the server device 3 can be connected to each other via the network 5 and the server device 3 and the store terminal device 4 can be connected to each other via the network 5, the vehicle 2 and the store terminal device 4 do not have to be directly connected with each other.

The vehicle 2 includes an information processing device 10 that presents a store in which the user can receive a bonus. The information processing device 10 is, for example, a car navigation device, and details thereof will be described later.

The server device 3 is constituted by a computer including a central processing unit (CPU), a read only memory (ROM), a random access memory (RAM), and a memory. When receiving store information from the store terminal device 4, the server device 3 stores the received store information in the memory. The server device 3 also transmits the store information stored in the memory to the information processing device 10 of the vehicle 2.

The store terminal device 4 is provided for each store and is constituted by a computer including a CPU, a ROM, a RAM, and a memory. For example, a store clerk inputs store information to the store terminal device 4, and the store terminal device 4 transmits the input store information to the server device 3.

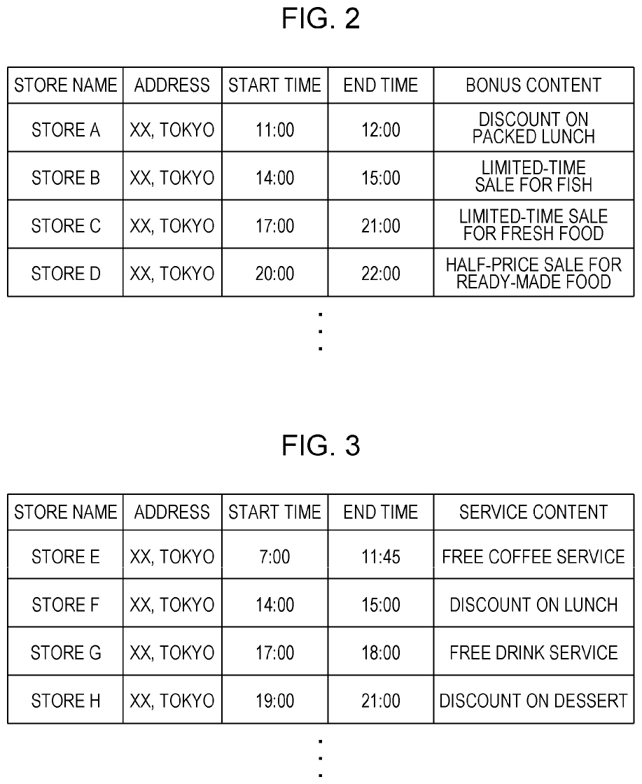

FIGS. 2 and 3 are diagrams illustrating lists of store information. FIG. 2 is a diagram illustrating a list of store information on stores whose genre is a supermarket. FIG. 3 is a diagram illustrating a list of store information on stores whose genre is a restaurant.

As illustrated in FIGS. 2 and 3, the store information includes a store name, an address, a start time at which provision of a bonus is started, an end time at which the provision of the bonus is ended, a bonus content, and the like.

The information included in the store information is not limited thereto, and may include, for example, a genre of the store, a date on which the bonus is provided, business hours (store opening time and store closing time), and the like.

The bonus refers to any benefit or treatment for the user, such as a discount on a product or a service, or free provision of a product or a service.

Also, the period between the start time and the end time is a period in which the store provides the bonus, in other words, a period in which the user can receive the bonus. Hereinafter, the period in which the bonus is provided may be referred to as a bonus provision period.

The genre of the store is a type or a category for classifying the store, and is, for example, a supermarket, a restaurant, an entertainment facility, a department store, or the like.

When the store terminal device 4 transmits the store information to the server device 3, the server device 3 stores the store information in the memory in association with the genre of the store.

The store terminal device 4 may transmit a part of the store information to the server device 3, and the server device 3 may store the transmitted part of the store information and the information of the store terminal device 4 stored in advance in the server device 3 in association with each other as the store information in the memory.

In this way, each time the server device 3 receives store information from the store terminal device 4, the store information is stored in the memory.

### 2. Configuration of Information Processing Device

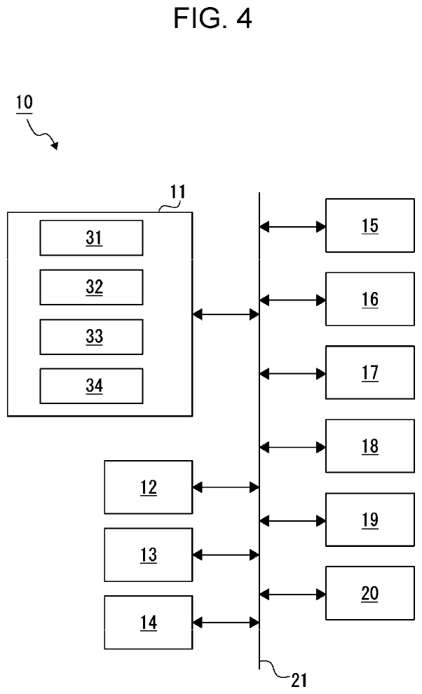

FIG. 4 is a diagram illustrating a configuration of the information processing device 10. As illustrated in FIG. 4, the information processing device 10 is constituted by a computer including a CPU 11, a ROM 12, a RAM 13, and a memory 14. The information processing device 10 also includes an input unit 15, a display 16, a voice output unit 17, a position information detector 18, a congestion information acquirer 19, and a communication unit 20.

In the information processing device 10, the CPU 11, the ROM 12, the RAM 13, the memory 14, the input unit 15, the display 16, the voice output unit 17, the position information detector 18, the congestion information acquirer 19, and the communication unit 20 are connected to one another via a bus 21, and control signals, data, detection signals, and the like, which are to be used, are exchanged among the units.

The CPU 11 performs various kinds of processing according to programs loaded into the RAM 13 from the ROM 12 or the memory 14. The RAM 13 also appropriately stores data and the like to be used for the CPU 11 to execute various kinds of processing.

The memory 14 is constituted by a hard disk drive (HDD), a flash memory, or the like. The memory 14 stores a program for implementing the processing of the present embodiment. Also, the memory 14 stores information to be used for the processing of the present embodiment, such as map information, set route information, and store information.

The input unit 15 includes, for example, a touch panel provided on the front surface of the display 16, buttons disposed around the display 16, and the like. When the input unit 15 detects an operation by the user, a signal corresponding to the input operation is input to the CPU 11.

The display 16 includes a display device such as a liquid crystal display (LCD) or an organic electro-luminescence (EL) display, and displays various kinds of information to the user.

The display 16 displays various images (screens) based on instructions from the CPU 11. Also, the display 16 displays various operation menus, icons, messages, and the like, as a graphical user interface (GUI) based on instructions from the CPU 11.

The voice output unit 17 includes a speaker, an amplifier, and the like, and outputs various sounds based on instructions from the CPU 11. For example, guidance voice is output at the time of route guidance.

The position information detector 18 includes a global navigation satellite system (GNSS) sensor, and detects the current position of the vehicle 2. The position information detector 18 outputs information relating to the detected current position of the vehicle 2 to the CPU 11 as current position information. The current position information input to the CPU 11 is used for processing for route guidance.

The congestion information acquirer 19 includes a sensor capable of receiving frequency modulation (FM) multiplex broadcasting, optical beacons, and radio beacons, and acquires congestion information transmitted from, for example, a Vehicle Information Communication System (VICS, registered trade mark) center. Then, the congestion information acquirer 19 outputs the acquired congestion information to the CPU 11.

The congestion information includes information relating to congestion such as a position where congestion occurs and a period to pass through the congestion.

The congestion information acquirer 19 may acquire the congestion information via the network 5.

The communication unit 20 performs communication processing via the network 5. The CPU 11 performs various kinds of data communication with an external device connected to the network 5, for example, the server device 3 via the communication unit 20.

### 3. Bonus Store Presentation Processing

Next, bonus store presentation processing to be executed by the information processing device 10 will be described. The CPU 11 serves as a route setting unit 31, a store information acquirer 32, a store extractor 33, and a presentation controller 34 when executing the bonus store presentation processing.

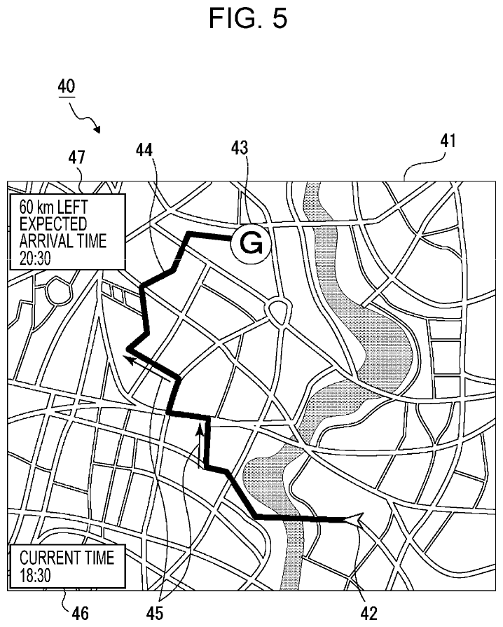

FIG. 5 is a diagram illustrating a navigation screen 40. When the user inputs a destination via the input unit the route setting unit 31 sets a route for the vehicle 2 to travel from the current position to the destination in accordance with a route condition (recommended route, fastest route, or the like) set in advance.

For example, the route setting unit 31 sets a route with reference to map information stored in the memory 14 based on a current position detected by the position information detector 18, an input destination, and congestion information acquired by the congestion information acquirer 19. Since an existing method can be used as a method of setting a route, detailed description thereof will be omitted here.

When the route is set by the route setting unit 31, information relating to the route is stored as route information in the memory 14. Also, the presentation controller 34 displays a navigation screen 40 in which a current position mark 42, a destination mark 43, a route line 44, a congestion mark 45, a current time display area 46, and an arrival expectation information display area 47 are superimposed on a map screen 41 in a predetermined range including the current position.

The current position mark 42 is a mark indicating the current position of the vehicle 2 on the map screen 41.

The destination mark 43 is a mark indicating the destination on the map screen 41.

The route line 44 is a line indicating the route set by the route setting unit 31 on the map screen 41.

The congestion mark 45 is a mark indicating a congestion occurrence place indicated in the congestion information on the map screen 41.

The current time display area 46 is an area in which a current time is displayed.

The arrival expectation information display area 47 is an area in which a distance to the destination and an expected arrival time are displayed. The distance to the destination and the expected arrival time are calculated by the route setting unit 31 when the route is set by the route setting unit 31 and at predetermined time intervals.

In this way, when the user inputs the destination, the navigation screen 40 is displayed by the presentation controller 34, and hence route guidance is started. In the route guidance, a guidance voice is appropriately output from the voice output unit 17.

When the vehicle 2 is caught in congestion, the time at which the vehicle 2 arrives at the destination is delayed. In the vicinity of the route on which the vehicle 2 travels, there is a store where the vehicle 2 does not arrive within the bonus provision period if the vehicle 2 is not caught in congestion, but the vehicle 2 can arrive within the bonus provision period if the vehicle 2 is caught in congestion and the traveling speed decreases.

For example, there is a case where the vehicle 2 arrives at a store whose bonus provision period is 11:00 to 12:00, at 10:30 if the vehicle 2 is not caught in congestion, but the vehicle 2 arrives at the store at 11:30 if the vehicle 2 is caught in congestion. That is, the vehicle 2 can arrive at the store within the bonus provision period because the vehicle 2 is caught in congestion.

Thus, when a route to a destination is set and the vehicle 2 is caught in congestion, the information processing device 10 presents, to the user, a store where the vehicle 2 can arrive in a period in which a bonus is provided.

The situation in which “the vehicle 2 can arrive in a period in which a bonus is provided” includes a case where the vehicle 2 arrives within the bonus provision period and a case where the vehicle 2 arrives at a time a predetermined period earlier than the bonus provision period (for example, 10 minutes earlier).

Accordingly, although the arrival at the destination is delayed because the vehicle 2 is caught in congestion, the user can get to the store that provides the bonus because the vehicle 2 is caught in congestion, and the user can obtain a sense of satisfaction by receiving the bonus.

For example, when the user inputs a genre of a store in which a bonus is provided via the input unit 15 while a route to a destination is set, the store information acquirer 32 transmits genre information indicating the input genre of the store to the server device 3.

When receiving the genre information, the server device 3 transmits a list of store information associated with the genre indicated in the genre information to the information processing device 10.

The store information acquirer 32 receives the store information transmitted from the server device 3.

The store extractor 33 extracts, from among stores indicated in the store information received by the store information acquirer 32, a store that is located within a predetermined range from the route indicated in the route information, that has a congestion occurrence place on the route to the store, and where the vehicle 2 can arrive within a presentable period (described later).

The predetermined range from the route is a range determined in advance such as a range within a predetermined distance from the route or a range in which the vehicle 2 can arrive within a predetermined period from the route.

The presentable period is a period determined based on the bonus provision period (start time, end time), and indicates a period in which the user can receive the bonus with certainty or a high probability when the vehicle 2 arrives at the store within the period.

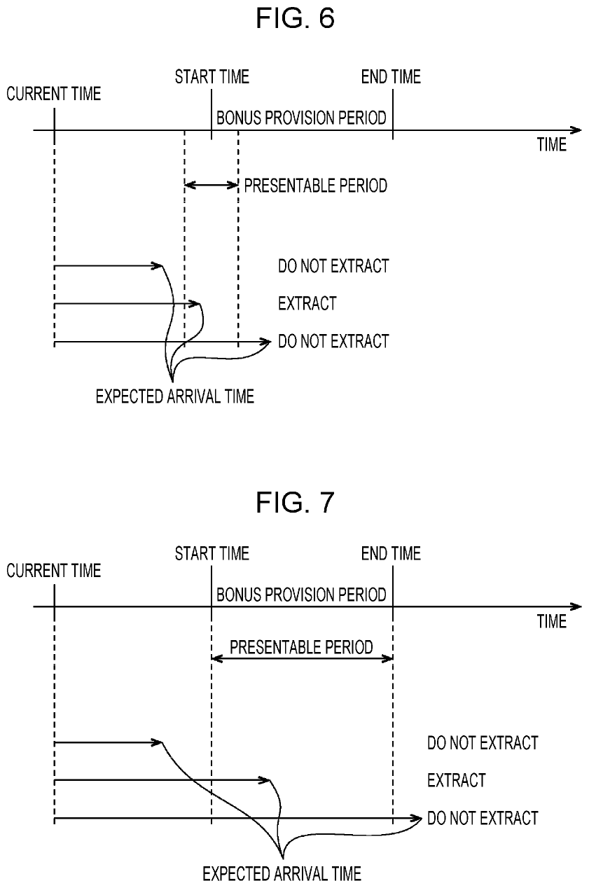

FIG. 6 is a diagram illustrating a presentable period set with reference to a start time. FIG. 7 is a diagram illustrating a presentable period based on a start time and an end time.

The store extractor 33 extracts stores located within the predetermined range from the route from among the stores indicated in the store information received by the store information acquirer 32.

The store extractor 33 also calculates routes to the stores with reference to the map information stored in the memory 14 based on the current position, addresses indicated in the store information, and the congestion information acquired by the congestion information acquirer 19 for the extracted stores, and extracts a store with a congestion occurrence place on the route.

Accordingly, the store extractor 33 can extract, from among the stores indicated in the store information received by the store information acquirer 32, the store that is located within the predetermined range from the route indicated in the route information and that has the congestion occurrence place on the route to the store.

Thereafter, the store extractor 33 calculates an expected arrival time at the store based on the calculated route and the congestion information for the extracted store.

For example, when the genre of the store is a supermarket, as illustrated in FIG. 6, the store extractor 33 sets a predetermined time range (for example, ±10 minutes) before and after the start time as a presentable period. Then, the store extractor 33 extracts a store that the expected arrival time is within the presentable period.

For example, when the genre of the store is a restaurant, as illustrated in FIG. 7, the store extractor 33 sets the period between the start time and the end time, that is, the bonus provision period as a presentable period. Then, the store extractor 33 extracts a store that the expected arrival time is within the presentable period.

In this way, the store extractor 33 sets the presentable period based on the reference that is different for each genre of the store, and extracts a store that the expected arrival time is within the presentable period. This is because whether the user can receive the bonus differs depending on the store or the genre of the store even if the user arrives within the bonus provision period.

For example, when the store is a restaurant, if the user can arrived at the store within the bonus provision period, the user can receive the bonus.

In contrast, when the store is a supermarket, there is a limit to products that can be purchased at a discount that is a bonus. Thus, even if the user arrives at the store within the bonus provision period, the user is not able to purchase the product in some cases. Thus, when the store is a supermarket, a store is extracted when it is possible to arrive at the store within a predetermined period before or after the start time in which the user can purchase the product with a high possibility.

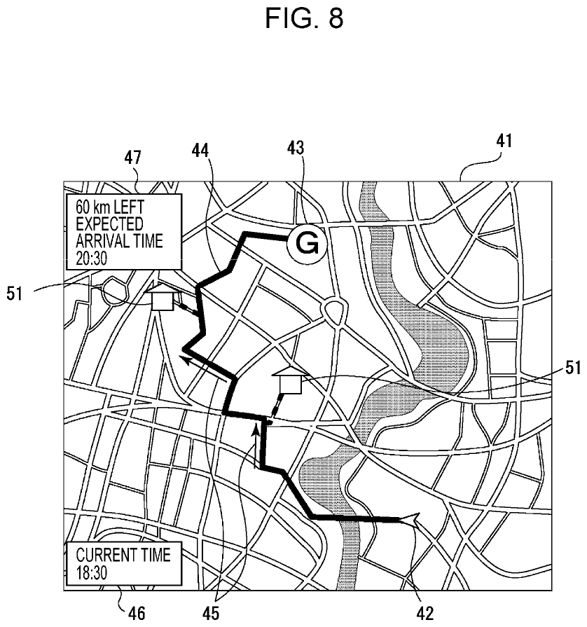

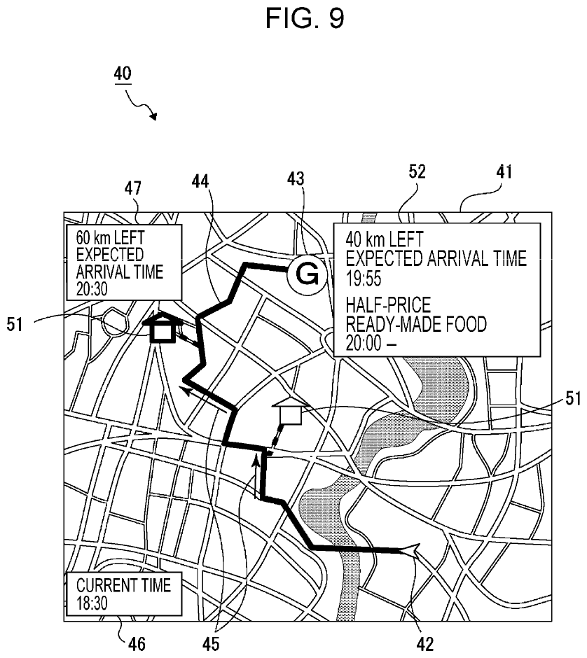

FIG. 8 and FIG. 9 are diagrams illustrating an example of presenting stores that provides bonuses. As illustrated in FIG. 8, the presentation controller 34 displays store marks 51 indicating stores extracted by the store extractor 33 in a superimposed manner on the map screen 41 based on the addresses of the stores.

Accordingly, the presentation controller 34 can visually present the positions of the stores that provide the bonuses to the user. Then, when any one of the store marks 51 is operated (touched) via the input unit 15, as illustrated in FIG. 9, the store mark 51 is highlighted and information (hereafter, bonus information) relating to the bonus of the store corresponding to the store mark 51 is displayed in a bonus information display area 52.

In the bonus information display area 52, for example, a distance to the store, an expected arrival time at the store, a bonus content, and a start time and an end time of the bonus are displayed.

For example, in the example of FIG. 9, the distance to the store is 40 km, and the expected arrival time is 19:55. In addition, the bonus content is a half-price ready-made food, the start time of the bonus is 20:00, and the end time of the bonus is 22:00.

In this way, after the store mark 51 and the bonus information display area 52 are displayed, when an instruction to perform guidance to the store is given by an operation of the user on the input unit 15, the information processing device 10 starts route guidance to the store.

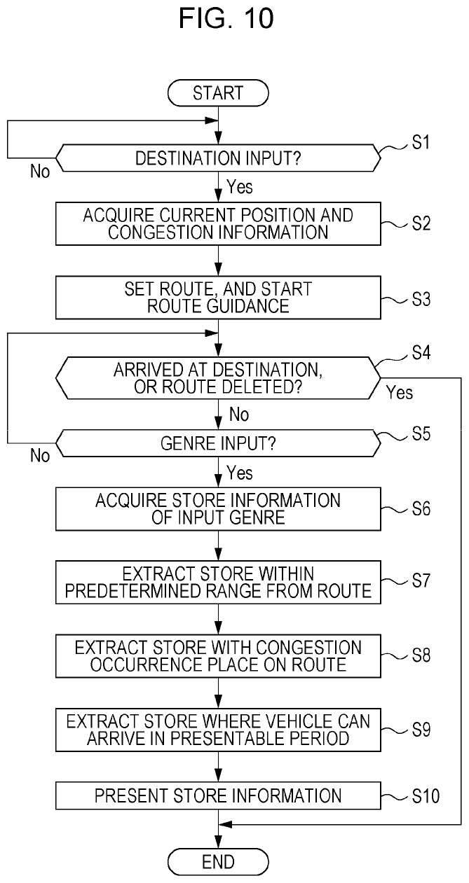

FIG. 10 is a flowchart illustrating a flow of the bonus store presentation processing. As illustrated in FIG. 10, in step S1, the route setting unit 31 determines whether a destination has been input. Then, step S1 is repeated until the destination is input, and when the destination has been input (Yes in step S1), in step S2, the route setting unit 31 acquires current position information and congestion information.

In step S3, the route setting unit 31 refers to map information stored in the memory 14 based on the current position, the input destination, and the congestion information, sets a route from the current position to the destination, and stores route information in the memory 14. The presentation controller 34 also displays a navigation screen 40 as illustrated in FIG. 6 on the display 16 based on the route information and the like, and starts route guidance to the destination.

In step S4, the route setting unit 31 determines whether the vehicle 2 has arrived at the destination or there has been an input to delete the route. As a result, when the vehicle 2 has arrived at the destination or when there has been the input to delete the route (Yes in step S4), the processing is ended.

In contrast, when the vehicle 2 has not arrived at the destination and there has not been the input to delete the route (No in step S4), in step S5, the store information acquirer 32 determines whether a genre of a store has been input. When the genre of the store has not been input (No in step S5), the processing returns to step S4.

In contrast, when the genre of the store has been input (Yes in step S5), in step S6, the store information acquirer 32 acquires store information of the input genre from the server device 3.

In step S7, the store extractor 33 extracts stores within a predetermined range from the route based on the route information from among stores indicated in the store information. Also, in step S8, the store extractor 33 extracts stores with congestion occurrence places on routes to the stores from among the stores extracted in step S7. Further, in step S9, the store extractor 33 extracts a store that the expected arrival time is within a presentable period from among the stores extracted in step S8.

Then, in step S10, the presentation controller 34 displays a store mark 51 indicating the store extracted in step S9 in a superimposed manner on the map screen 41, and displays a bonus information display area 52 when the store mark 51 is operated. That is, the presentation controller 34 presents, to the user, a store that provides a bonus.

### 3. Modifications

Although the embodiment of the disclosure has been described above, the disclosure is not limited to the above-described example, and various configurations can be adopted.

For example, in the above-described embodiment, the CPU 11 of the information processing device 10 serves as the store extractor 33. However, the CPU of the server device 3 may serve as the store extractor 33. That is, the CPU of the server device 3 may extract, from among the stores indicated in the store information of the genre input by the user, a store that is located within the predetermined range from the route indicated in the route information, that has a congestion occurrence place on the route to the store, and where the vehicle 2 can arrive within the presentable period.

In the above-described embodiment, the store information input to the store terminal device 4 is stored in the memory of the server device 3, and the store information is transmitted from the server device 3 to the information processing device 10. However, the store information may be directly transmitted from the store terminal device 4 to the information processing device 10. In this case, the server device 3 does not have to be provided.

In the above-described embodiment, the store extractor 33 extracts the store that is located within the predetermined range from the route indicated in the route information, that has the congestion occurrence place on the route to the store, and where the vehicle 2 can arrive within the presentable period from among the stores indicated in the store information of the genre input by the user. However, the store extractor 33 may extract a store where the vehicle 2 can arrive within the presentable period regardless of the presence of congestion.

In the above-described embodiment, the reference of the presentable period is different for each genre. However, for example, the reference of the presentable period may be different for each store or for each bonus provision period. Also, for all stores, the presentable period may be the bonus provision period.

In the above-described embodiment, the information processing device 10 is provided in the vehicle 2. However, the information processing device 10 may be, for example, a smartphone, a personal computer, or the like, and does not have to be provided in the vehicle 2.

### 4. Summary of Embodiment

As described above, an information processing device 10 according to the embodiment includes a presentation controller 34 configured to present, to a user, a store that is extracted based on route information relating to a route on which a vehicle 2 travels and store information including a period in which a bonus is provided. The store is where the vehicle 2 can arrive in the period in which the bonus is provided.

Accordingly, the information processing device 10 can present, to the user, the store where the vehicle 2 can arrive in the period in which the bonus is provided in the vicinity of the route of the vehicle 2.

Thus, since the user can receive the bonus at the store, the information processing device 10 can give a sense of satisfaction to the user.

The information processing device 10 further includes a store information acquirer 32 configured to acquire the store information; and a store extractor 33 configured to calculate an expected arrival time at the store indicated in the store information, and extract the store where the vehicle 2 can arrive in the period in which the bonus is provided, based on a relationship between the expected arrival time and the period in which the bonus is provided. The presentation controller 34 is configured to present the store extracted by the store extractor 33 to the user.

Accordingly, when the information processing device 10 acquires the store information from the server device 3, the information processing device 10 can extract the store where the vehicle 2 can arrive in the period in which the bonus is provided.

Thus, it is possible to reduce the processing load of the server device 3.

The store information includes at least a start time of the bonus. The presentation controller 34 is configured to present, to the user, the store where the vehicle 2 can arrive within a presentable period that is set with reference to the start time.

Accordingly, the information processing device 10 can properly present the store at which the user can receive the bonus with certainty or a high probability, such as presenting a store where the vehicle 2 can arrive at an earlier time in the bonus provision period such as when the store is a supermarket.

The store information includes at least the start time and an end time of the bonus. The presentation controller 34 is configured to present, to the user, the store where the vehicle 2 can arrive in a period between the start time and the end time.

Accordingly, the information processing device 10 can properly present, to the user, the store at which the user can receive the bonus.

The presentation controller 34 is configured to present, to the user, the store that is on a route on which the vehicle 2 is caught in congestion. The store is where the vehicle 2 can arrive in the period in which the bonus is provided.

Accordingly, it is possible to give the user a sense of further satisfaction that the user can receive the bonus because the vehicle 2 is caught in congestion.

1. An information processing device comprising:
a presentation controller configured to present, to a user, a store that is extracted based on route information relating to a route on which a vehicle travels and store information comprising a period in which a bonus is provided, the store being where the vehicle can arrive in the period in which the bonus is provided,
wherein the store information comprises at least a start time of the bonus, and
wherein the presentation controller is configured to present, to the user, the store where the vehicle can arrive within a predetermined time range before the start time.

2. The information processing device according to claim 1, further comprising:
a store information acquirer configured to acquire the store information; and
a store extractor configured to calculate an expected arrival time at the store indicated in the store information, and extract the store where the vehicle can arrive in the period in which the bonus is provided, based on a relationship between the expected arrival time and the period in which the bonus is provided,
wherein the presentation controller is configured to present the store extracted by the store extractor to the user.

3. The information processing device according to claim 1,
wherein the store information comprises at least the start time and an end time of the bonus, and
wherein the presentation controller is configured to present, to the user, the store where the vehicle can arrive in a period between the start time and the end time.

4. The information processing device according to claim 1,
wherein the presentation controller is configured to present, to the user, the store that is on a route on which the vehicle is caught in congestion, the store being where the vehicle can arrive in the period in which the bonus is provided.

5. An information processing device comprising:
circuitry configured to present, to a user, a store that is extracted based on route information relating to a route on which a vehicle travels and store information comprising a period in which a bonus is provided, the store being where the vehicle can arrive in the period in which the bonus is provided,
wherein the store information comprises at least a start time of the bonus, and
wherein the circuitry is configured to
present, to the user, the store where the vehicle can arrive within a predetermined time range before the start time.
